(19) United States
(12) Patent Application Publication
(10) Pub. No.: US 2009/0136783 A1
(43) Pub. Date: May 28, 2009

(54) MAGNETIC RECORDING MEDIUM AND PROCESS FOR PRODUCTION OF MAGNETIC RECORDING MEDIUM

(75) Inventors: Nobuhiro Jingu, Tokyo (JP); Mamoru Satoh, Tokyo (JP); Kenichi Kitamura, Tokyo (JP); Megumi Yoshimura, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Chuo-ku (JP)

(21) Appl. No.: 12/276,045

(22) Filed: Nov. 21, 2008

(30) Foreign Application Priority Data
Nov. 22, 2007 (JP) P2007-303504

(51) Int. Cl. B32B 5/02; B05D 5/12

(52) U.S. Cl. 428/840.6; 427/132

(57) ABSTRACT

The invention provides a magnetic recording medium with both weather resistance and high recording density. The magnetic recording medium of the invention has a magnetic layer comprising at least SmCo-based magnetic fine particles and a hydrophobic binder, wherein the SmCo-based magnetic fine particles include a core composed of SmCo-based nanoparticles and a hydrophilic polymer covering at least a portion of the surface of the core.

### BACKGROUND OF THE INVENTION

1. Field of the Invention

The present invention relates to a magnetic recording medium and to a process for production of a magnetic recording medium.

2. Related Background Art

A magnetic recording tape is a type of magnetic recording medium that is usually composed of a base film, a magnetic layer formed on one side of the base film, and a backcoat layer formed on the other side of the base film. The magnetic layer is a layer comprising a magnetic material and a binder (resin material), while the backcoat layer is a layer comprising a non-magnetic powder such as carbon black and a binder. Recent years have seen increased demand for longer-term storage and higher recording density of magnetic recording media in order to meet the needs of the advancing IT society, especially in light of the introduction of new regulations under the SOX Act and e-Document Law, for example.

Japanese Unexamined Patent Publication No. 2006-245313 discloses SmCo-based magnetic fine particles composed of a SmCo alloy, as an example of a magnetic material which is used in magnetic layers of magnetic recording media. SmCo alloys exhibit extremely high uniaxial magnetocrystalline anisotropy and are therefore suitable as magnetic materials for magnetic recording media with high recording density.

### SUMMARY OF THE INVENTION

Since the surfaces of the aforementioned SmCo-based magnetic fine particles are hydrophilic, the SmCo-based magnetic fine particles disperse easily in ordinary binders and especially in hydrophilic binders due to their affinity for hydrophilic binders. Therefore, if a magnetic layer is formed using SmCo-based magnetic fine particles and a hydrophilic binder, the SmCo-based magnetic fine particles disperse evenly in the magnetic layer. With such magnetic layers, however, the hydrophilic binder will tend to absorb water (moisture) in the air, and this moisture causes oxidation of the SmCo-based magnetic fine particles and leads to degradation of the magnetic properties of the magnetic fine particles. Magnetic recording media must have magnetic fine particles that are resistant to oxidation with long-term storage of recorded data, while the magnetic fine particles and magnetic recording media must also have magnetic properties that are resistant to degradation (hereinafter referred to as “weather resistance”), for which reason it has been necessary to deal with the problems of absorption of moisture by the hydrophilic binder and the oxidation of SmCo-based magnetic fine particles caused by moisture.

Micronization of SmCo-based magnetic fine particles with excellent magnetic properties is also in demand for higher recording density in magnetic recording media, but increased micronization of SmCo-based magnetic fine particles increases the area-to-weight ratio of the SmCo-based magnetic fine particles, thus rendering the SmCo-based magnetic fine particles more susceptible to oxidation. Thus, increasing the recording density of a magnetic recording medium leads to easier oxidation of the SmCo-based magnetic fine particles, and tends to impair the weather resistance of the magnetic recording medium.

The present invention has been accomplished in light of these problems, and its object is to provide a magnetic recording medium with both weather resistance and high recording density, as well as a process for production of a magnetic recording medium which allows the aforementioned magnetic recording medium to be easily obtained.

In order to achieve this object, the magnetic recording medium of the invention is provided with a magnetic layer comprising at least SmCo-based magnetic fine particles and a hydrophobic binder, wherein the SmCo-based magnetic fine particles include a core composed of SmCo-based nanoparticles and a hydrophilic polymer covering at least a portion of the surface of the core.

SmCo-based nanoparticles according to the invention are particles composed of a SmCo-based alloy and having a mean particle size of at least 1 nm and less than 100 nm.

In the magnetic layer of the magnetic recording medium of the invention, SmCo-based magnetic fine particles that include a core composed of hydrophilic SmCo-based nanoparticles and a hydrophilic polymer covering at least a portion of the surface of the core are dispersed in a hydrophobic binder, so that they are surrounded by the hydrophobic binder. Since the SmCo-based nanoparticles are covered with a hydrophilic polymer that has affinity with the hydrophobic binder as well, they are satisfactorily dispersed in the hydrophobic binder. The hydrophobic binder does not readily absorb moisture in the air, and therefore oxidation of the SmCo-based nanoparticles in the hydrophobic binder by moisture can be prevented. According to the invention, therefore, it is possible to prevent oxidation of the SmCo-based nanoparticles and degradation of the magnetic properties and thus improve the weather resistance of the magnetic recording medium, compared to when no hydrophobic binder is used.

Also, since the magnetic material employed according to the invention consists of SmCo-based magnetic fine particles having a core of SmCo-based nanoparticles that exhibit extremely high uniaxial magnetocrystalline anisotropy and are micronized to a mean particle size of at least 1 nm and less than 100 nm, it is possible to obtain a magnetic recording medium with higher recording density.

The process for production of a magnetic recording medium according to the invention is characterized by comprising a step in which a reaction mixture comprising a Sm salt, a Co salt and a hydrophilic polymer dissolved or dispersed in a solvent is heated to obtain a mixture containing SmCo-based nanoparticles and the hydrophilic polymer, a step in which a hydrophobic binder is added to the mixture to obtain a magnetic coating material and a step in which the magnetic coating material is used to form a magnetic layer comprising at least a hydrophobic binder and SmCo-based magnetic fine particles that include a core composed of SmCo-based nanoparticles and a hydrophilic polymer covering at least part of the surface of the core.

This production process can easily form a magnetic recording medium according to the invention.

In the process for production of a magnetic recording medium according to the invention, a surfactant is preferably added to the magnetic coating material.

If the magnetic layer formed from the magnetic coating material contains a surfactant, the SmCo-based magnetic fine particles will disperse even more easily in the hydrophobic binder and will be surrounded more readily by the hydrophobic binder, thus helping to further prevent oxidation of the SmCo-based nanoparticles by moisture and improving the weather resistance and recording characteristics of the magnetic recording medium. Including a surfactant in the magnetic layer can also improve the rigidity of the magnetic layer.

According to the invention, it is possible to provide a magnetic recording medium with both weather resistance and high recording density. Also according to the invention, it is possible to provide a production process whereby a magnetic recording medium with both weather resistance and high recording density can be easily obtained.

### BRIEF DESCRIPTION OF THE DRAWINGS

FIG. 1 is a cross-sectional schematic drawing of a magnetic recording tape according to an embodiment of the invention.

FIG. 2 is a cross-sectional schematic drawing of SmCo-based magnetic particles in the magnetic layer of a magnetic recording tape according to an embodiment of the invention.

### DESCRIPTION OF THE PREFERRED EMBODIMENTS

A preferred embodiment of the invention will now be explained in detail, with reference to the accompanying drawings. However, the present invention is not limited to the embodiments described below. Throughout the explanation of the drawings, identical or corresponding elements will be referred to by like reference numerals and will be explained only once. Also, the dimensional proportions in the drawings do not necessarily match the actual dimensional proportions.

(Magnetic Recording Medium)

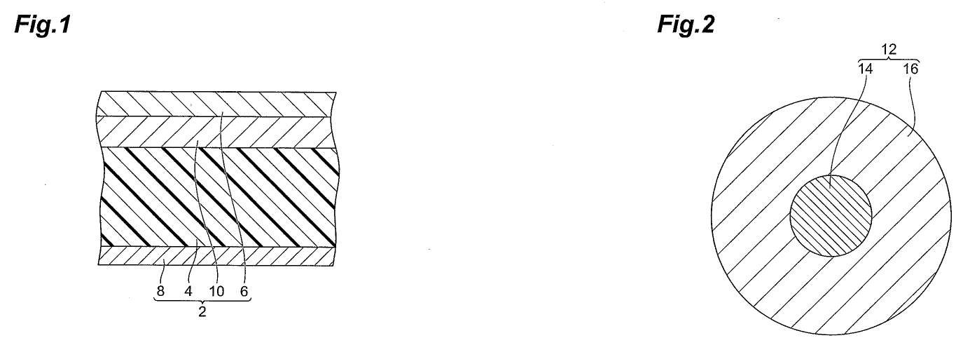

As shown in FIG. 1, the magnetic recording medium (magnetic recording tape 2) of this embodiment comprises a base film 4, magnetic layer 6 and backcoat layer 8. A backcoat layer 8 is laminated on one side of the base film 4. Also, an undercoat layer 10 is preferably laminated on the other side of the base film 4, with the magnetic layer 6 preferably laminated on the undercoat layer 10. The magnetic recording tape 2 is thus constructed in such a manner as to allow recording and reproduction of various types of recording data with a recording/playback device.

(Magnetic Layer 6)

The magnetic layer 6 contains at least SmCo-based magnetic fine particles 12 and a hydrophobic binder. The hydrophobic binder is uniformly distributed in the magnetic layer 6, with the SmCo-based magnetic fine particles 12 dispersed in the hydrophobic binder.

The center line average roughness Ra of the surface of the magnetic layer 6 is preferably 1-2 nm. If the center line average roughness Ra of the surface of the magnetic layer 6 is too small, the surface of the magnetic layer 6 will be too smooth, tending to interfere with the running stability of the magnetic recording tape 2 and potentially resulting in more trouble during running of the tape. An overly large center line average roughness Ra of the surface of the magnetic layer 6, on the other hand, will result in poor recording characteristics, including playback output, in a playback system employing the MR head. By limiting the center line average roughness Ra of the surface of the magnetic layer 6 to within the aforementioned preferred range, it will be possible to prevent such problems and improve the recording characteristics of the magnetic recording tape 2.

The thickness of the magnetic layer 6 is preferably 0.01-0.08 μm. If the thickness of the magnetic layer 6 is too small, the number of SmCo-based magnetic fine particles 12 in the thickness direction of the magnetic layer 6 will be reduced, thus lowering the flux density and interfering with the carrier output. If the thickness of the magnetic layer 6 is too large, the self-demagnetization loss or thickness loss will be increased. By limiting the thickness of the magnetic layer 6 to within the aforementioned preferred range, it will be possible to prevent such problems and improve the recording characteristics of the magnetic recording tape 2.

<SmCo-Based Magnetic Fine Particles 12>

As shown in FIG. 2, the SmCo-based magnetic fine particles 12 in the magnetic layer 6 include SmCo-based nanoparticles 14 (core) and a hydrophilic polymer 16 covering at least part of the surfaces of the SmCo-based nanoparticles 14. The hydrophilic polymer 16 shown in FIG. 2 shows not a single molecule of the hydrophilic polymer 16, but rather a schematic view of the layer formed from the plurality of hydrophilic polymers 16 covering the surface of the core 14.

<SmCo-Based Nanoparticles 14>

The SmCo-based nanoparticles 14 having SmCo-based magnetic fine particles 12 as the core are composed of an SmCo-based alloy. An SmCo-based alloy can exhibit more excellent magnetic properties than conventional magnetic materials such as oxide magnetic materials, simple metals or Fe—Co alloys, since they have much greater magnetocrystalline anisotropy than conventional magnetic materials. Adding SmCo-based magnetic fine particles 12 to the magnetic layer 6 instead of a conventional magnetic material can improve the thermostability of the magnetic recording tape 2 and increase the reliability of the magnetic recording tape 2.

The SmCo-based alloy may also be a combination of different alloys with different molar ratios of Sm and Co. Such SmCo-based alloys can be formed if the charging amounts of each of the materials such as Sm and Co, as well as the reaction conditions, are appropriately adjusted during synthesis.

The mean particle size of the SmCo-based nanoparticles 14 is at least 1 nm and less than 100 nm, and is preferably 2-80 nm. If the mean particle size of the SmCo-based nanoparticles 14 is greater than 80 nm, the surface properties of the magnetic layer 6 will be poor and the packing density of the SmCo-based magnetic fine particles 12 in the magnetic layer 6 will be reduced, thus lowering the magnetic properties of the magnetic recording tape 2 for short wavelength recording. If the mean particle size of the SmCo-based nanoparticles 14 is smaller than 2 nm, the proportion of the surface oxidation layer with respect to the volume of the SmCo-based nanoparticles 14 will be increased, thus tending to lower the magnetic properties of the SmCo-based nanoparticles 14. By limiting the mean particle size of the SmCo-based nanoparticles 14 to 2-20 nm, it will be possible to prevent such problems and improve the magnetic properties and recording characteristics of the magnetic recording tape 2.

Magnetic recording tapes generally have a magnetic layer thickness of 0.1-0.2 μm when wetted, and magnetic fine particles whose diameter exceeding that film thickness cannot be used. For most purposes, therefore, the mean particle size of magnetic fine particles used in the magnetic layer of a magnetic recording tape must be no greater than 0.1 μm (100 nm). When magnetic fine particles with a mean particle size larger than 0.1 μm are used, the center line roughness Ra of the magnetic layer surface increases, rendering the head susceptible to wear by contact with the magnetic layer surface, and if extra space is provided between the tape (magnetic layer) and head to prevent head wear there may arise problems such as reduced recording and playback output. From the viewpoint of avoiding such problems, the mean particle size of the SmCo-based nanoparticles 14 is preferably within the preferred range specified above.

The SmCo-based nanoparticles 14 are preferably spherical. This will reduce the area-to-weight ratio of the SmCo-based nanoparticles 14, thus helping to reduce oxidation of the SmCo-based nanoparticles 14 and improving the weather resistance of the magnetic tape 2. In addition, spherical SmCo-based nanoparticles 14 will result in spherical SmCo-based magnetic fine particles 12 as well, thus increasing the packing density of the SmCo-based magnetic fine particles 12 in the magnetic layer 6 and thereby further improving the recording density of the magnetic recording tape 2.

<Hydrophilic Polymer 16>

The hydrophilic polymer 16 that covers the SmCo-based nanoparticles 14 in the SmCo-based magnetic fine particles 12 is a polymer having a highly polar group or charged group in the molecule, and having high affinity for water. Examples of specific hydrophilic polymers 16 include poly(N-vinyl-2-pyrrolidone), polyacrylic acid, polymaleic acid, polyglutamic acid and salts thereof, vinyl alcohol, polyethylene glycol, polypropylene glycol, polyacrylamide, polyvinylamine and polyethyleneimine, or derivatives and copolymers thereof, cellulose, water-soluble acrylic resins, water-soluble polyvinylacetals, water-soluble polyvinyl butyrals, water-soluble urethane resins, and the like. These hydrophilic polymers 16 have mutually crosslinkable structures. The average molecular weight of the hydrophilic polymer 16 is preferably 100-10,000 and more preferably 500-8000. If the molecular weight of the hydrophilic polymer 16 is too low it will become more difficult to synthesize the hydrophilic polymer 16, while it will also tend to be more difficult to thoroughly cover the surfaces of the SmCo-based fine particles 12 with the hydrophilic polymer 16. If the molecular weight of the hydrophilic polymer 16 is too high, on the other hand, the hydrophilic polymer 16 will not as easily dissolve in the solvent in the coating solution used to form the magnetic layer 6, while the molecular chains of the hydrophilic polymer 16 will become too long, leading to adsorption of multiple SmCo-based nanoparticles 14 on each hydrophilic polymer 16 and tending to prevent formation of monodisperse particles by the SmCo-based nanoparticles 14. However, these problems can be minimized if the average molecular weight of the hydrophilic polymer 16 is within the range specified above, thus helping to improve the dispersibility of the SmCo-based fine particles 12 in the hydrophobic binder.

<Hydrophobic Binder>

The hydrophobic binder in the magnetic layer 6 is electrically neutral with low polarity, and is therefore a binder having low affinity for water. The hydrophobic binder improves the humidity resistance of the magnetic layer 6 while also functioning to increase the coated film strength of the magnetic layer 6. Specifically, by appropriately selecting the molecular weight, Curie temperature (Tg) or molecular structure of the hydrophobic binder, it is possible to satisfy the properties of humidity resistance and coated film strength that are required for the magnetic recording tape 2. Specific examples of hydrophobic binders to be used include hydrophobic urethanes, vinyl chloride, polyamides and polyesters. The hydrophobic binder preferably has hydroxyl groups in the molecule, so long as its hydrophobicity is not reduced. This will allow the coated film strength of the magnetic layer 6 to be improved. These hydrophobic binders may also have mutually crosslinkable structures.

The average molecular weight of the hydrophobic binder is preferably about 5000-100,000 and more preferably about 10,000-50,000. If the average molecular weight of the hydrophobic binder is too low the effect of improved coated film strength of the magnetic layer 6 will tend to be reduced, while if the average molecular weight of the hydrophobic binder is too high, the hydrophobic binder will tend to dissolve less easily in the solvent of the coating solution used to form the magnetic layer 6. However, these problems can be minimized if the average molecular weight of the hydrophobic binder is within the preferred range specified above.

<Surfactant>

The magnetic layer 6 preferably further contains a surfactant in addition to the SmCo-based magnetic fine particles 12 and hydrophobic binder. The SmCo-based magnetic fine particles 12 in the magnetic layer 6 will thus become covered by the surfactant. Since the surfactant covering the SmCo-based magnetic fine particles 12 has hydrophobic groups in the molecule that exhibit affinity for the hydrophobic binder, it provides a function of evenly dispersing the SmCo-based magnetic fine particles 12 covered by the surfactant in the hydrophobic binder. In other words, the surfactant can function as a dispersing agent for dispersion of the SmCo-based magnetic fine particles 12 in the hydrophobic binder. Thus, by including a surfactant in the magnetic layer 6, the SmCo-based magnetic fine particles 12 will disperse even more easily in the hydrophobic binder and will be surrounded more readily by the hydrophobic binder, thus helping to further prevent oxidation of the SmCo-based nanoparticles 14 by moisture and improving the weather resistance and recording characteristics of the magnetic recording tape 2. Including a surfactant in the magnetic layer 6 can also increase the adhesion between the magnetic layer 6 and undercoat layer 10 and improve rigidity of the magnetic layer 6.

As surfactants there may be used, for example, anionic active agents, nonionic active agents and high molecular active agents. As anionic active agents there may be mentioned sulfonic acid-based active agents. As nonionic active agents there may be mentioned fatty acid-based, fatty acid ester-based, alkylamine-based and polyoxyethylenealkylamine-based active agents. As high molecular active agents there may be mentioned acrylic-based, urethane-based, vinyl alcohol-based and vinylpyrrolidone-based active agents. These surfactants preferably have structures that increase steric hindrance between the surfactant molecules toward the outside of the SmCo magnetic fine particles 12, after the SmCo magnetic fine particles 12 have been coated. This will inhibit aggregation between the SmCo-based magnetic fine particles 12 on the nanoscale, while facilitating uniform and high density distribution in the magnetic layer 6 of the magnetic recording tape 2. These surfactants may also have mutually crosslinkable structures.

Of the surfactants mentioned above, fatty acid-based active agents, alkylamine-based active agents and high molecular active agents are especially preferred as dispersing agents for kneading the SmCo-based nanoparticles 14 with the hydrophobic binder after the excess hydrophilic polymer 16 has been washed off from the hydrophilic polymer 16 covering the SmCo-based nanoparticles 14 during preparation of the coating solution used to form the magnetic layer 6. Also, fatty acid-based active agents such as oleic acid or stearic acid and alkylamine-based active agents such as oleylamine or stearylamine are preferred as surfactants from the viewpoint of cost, and they may be used alone or in combinations. Sulfur compounds such as thiols are also useful as surfactants. However, it is more preferred to use the surfactants mentioned above since parts of the tape drive interior may undergo corrosion in some cases.

The high molecular active agents mentioned above allow the number of active sites in the molecule (the sites to which the SmCo-based magnetic fine particles 12 are readily adsorbed) to be more easily controlled, and are therefore preferred as surfactants from the viewpoint of more easily controlling the number of SmCo-based magnetic fine particles 12 adsorbed onto each molecule of the high molecular active agent. If the average molecular weight of the high molecular active agent is too high, however, a larger number of SmCo-based magnetic fine particles 12 will tend to be taken up into the molecular chains of the high molecular active agent, thus interfering with monodispersion of the SmCo-based magnetic fine particles 12 in the hydrophobic binder. In addition, the number of SmCo-based magnetic fine particles 12 that can be adsorbed onto each molecule of the high molecular active agent will vary according to the ratio between the mean particle size of the SmCo-based magnetic fine particles 12 and the sizes of the high molecular active agent molecules. Consequently, the preferred range for the average molecular weight of the high molecular active agent (size of the active agent) will vary depending on the mean particle size of the SmCo-based magnetic fine particles 12.

Since the mean particle size of the SmCo-based nanoparticles 12 is less than 100 nm for this embodiment, the average molecular weight of the high molecular active agent is preferably no greater than 8000. A smaller average molecular weight of the high molecular active agent is preferred for smaller mean particle sizes of the SmCo-based nanoparticles 12, and when the mean particle size of the SmCo-based nanoparticles 12 is less than 20 nm, the average molecular weight of the high molecular active agent is preferably no greater than 5000.

The relationship between the mean particle size of the SmCo-based nanoparticles 12 and the preferred range for the average molecular weight of the high molecular active agent that depends on it, as explained above, is established for acrylic active agents and urethane-based polymer active agents with comparatively simple structures, and does not necessarily apply for high molecular active agents with particularly complex structures.

In the magnetic layer 6 of the magnetic recording tape 2 of this embodiment, the SmCo-based magnetic fine particles 12, which include SmCo-based nanoparticles 14 with a hydrophilic surface (core) and a hydrophilic polymer 16 covering the surface of the SmCo-based nanoparticles 14, are dispersed in a hydrophobic binder, and are surrounded by the hydrophobic binder. The hydrophobic binder does not readily absorb moisture in the air, and therefore oxidation of the SmCo-based nanoparticles 12 in the hydrophobic binder by moisture can be prevented. According to this embodiment, therefore, it is possible to prevent oxidation of the SmCo-based nanoparticles 12 and degradation of the magnetic properties, and thus improve the weather resistance of the magnetic recording tape 2, compared to when no hydrophobic binder is used.

Also, since the magnetic material employed for this embodiment consists of SmCo-based magnetic fine particles 12 having a core of SmCo-based nanoparticles 14 that exhibit extremely high uniaxial magnetocrystalline anisotropy and are micronized to a mean particle size of at least 1 nm and less than 100 nm, it is possible to obtain a magnetic recording tape 2 with higher recording density.

(Undercoat Layer 10)

As explained above, the magnetic recording tape 2 is preferably provided with an undercoat layer 10 between the base film 4 and magnetic layer 6. This can improve the recording characteristic of the magnetic recording tape 2 while also increasing the adhesiveness between the base film 4 and magnetic layer 6.

The center line average roughness Ra of the undercoat layer 10 is preferably 1-3 nm. If the center line average roughness Ra of the undercoat layer 10 is too high, the center line average roughness Ra of the undercoat layer 10 will affect the Ra of the magnetic layer 6 formed on the upper layer of the undercoat layer 10, thus tending to cause notable output fluctuation due to variation in the spacing between the head and tape. If the center line average roughness Ra of the undercoat layer 10 is too low, on the other hand, the friction force against the surface of the guide pin in the drive will be increased, thus tending to destabilize running of the magnetic recording tape 2. By limiting the center line average roughness Ra of the undercoat layer 10 to within the aforementioned preferred range, it will be possible to prevent such problems and improve the recording characteristics of the magnetic recording tape 2.

The thickness of the undercoat layer 10 is preferably 0.1-1.0 μm. By adjusting the thickness of the undercoat layer 10 within this range, it is possible to retain in the undercoat layer 10 the necessary amount of additives necessary to ensure running durability of the magnetic recording tape 2. Also, setting the thickness of the undercoat layer 10 to within the aforementioned range can minimize the effects of the surface roughness of the base film 4 on the magnetic layer 6, thereby reducing errors during recording and reproduction with the magnetic recording tape 2. Limiting the thickness of the undercoat layer 10 within the range of 0.1-1.0 μm is therefore important for ensuring the reliability of the magnetic recording tape 2 that is produced.

(Base Film 4)

The base film 4 can be formed from a resin material which may be, for example, a polyester resin such as polyethylene terephthalate or polyethylene naphthalate, or a polyamide, polyimide or polyamideimide.

(Backcoat Layer 8)

The backcoat layer 8 may be a layer with a known structure or composition and can be formed, for example, from carbon black, a non-magnetic inorganic powder other than carbon black, and a binder. The backcoat layer 8 can improve running of the magnetic recording tape 2 while preventing damage (wear) on the base film 4 and charging of the magnetic recording tape 2.

(Process for Production of Magnetic Recording Tape 2)

The process for production of the magnetic recording tape 2 of this embodiment comprises a step in which a reaction mixture comprising a Sm salt, a Co salt and a hydrophilic polymer dissolved or dispersed in a solvent is heated to obtain a mixture containing SmCo-based nanoparticles and the hydrophilic polymer (step 1), a step in which a hydrophobic binder is added to the mixture to obtain a magnetic coating material (step 2), and a step in which the magnetic coating material is used to form a magnetic layer comprising at least a hydrophobic binder and SmCo-based magnetic fine particles that include a core composed of SmCo-based nanoparticles and a hydrophilic polymer covering at least part of the surface of the core (step 3). The production process according to this embodiment can easily form the magnetic recording tape 2 described above.

<Step 1>

First, in step 1, a Sm salt (samarium salt), Co salt (cobalt salt) and hydrophilic polymer, for example, are dissolved in a solvent such as a glycol to form a reaction mixture.

For formation of the reaction mixture, the samarium salt is dissolved in a first solvent to form a first solution, the cobalt salt is dissolved in a second solvent to form a second solution, the hydrophilic polymer 16 is dissolved in a third solvent to form a third solution, and the first solution and second solution are added to and mixed with the third solution.

The samarium salt is preferably samarium acetylacetonate hydrate, and the cobalt salt is preferably cobalt acetylacetonate.

As the first, second and third solvents there may be used, for example, glycols such as ethylene glycol, diethylene glycol, triethylene glycol, tetraethylene glycol, pentaethylene glycol, 1,3-propanediol, 1,2-hexanediol and 2-methyl-2,4-pentanediol. The third solvent used to dissolve the hydrophilic polymer 16 is not particularly restricted so long as it is a solvent capable of dissolving the hydrophilic polymer 16, but a solvent with a relatively high boiling point of 200-300° C. is preferably used in order to increase the crystallinity of the obtained SmCo-based nanoparticles 14. Incidentally, the third solvent may be one that also functions as a reducing agent for the SmCo complexes present in the reaction mixture. When a third solvent without reducing activity is used, or when it is desired to promote reduction reaction in the third solution, a solid reducing agent such as LiAlH₄ or NaBH₄ may be dissolved in an appropriate solvent and the resulting solution added to the third solvent. A surfactant may also be added to the third solvent to produce a structure wherein the surfactant is adsorbed on the SmCo-based nanoparticles.

After then thoroughly stirring the reaction mixture, the reaction mixture is held at about 110° C. to remove the moisture. The reaction mixture is held at 150-320° C. for reaction. Upon completion of reaction with the reaction mixture by heating in this manner, it is allowed to stand until reaching room temperature, and then an ultrafilter is used for solution exchange with dehydrated ethanol or the like and washing of the particles, an evaporator is used to remove the solvent, and finally vacuum drying is performed, allowing a mixed product comprising the SmCo-based nanoparticles 14 and hydrophilic polymer 16 to be removed as a solid powder.

<Step 2>

In step 2, the mixture of the SmCo-based nanoparticles 14 and hydrophilic polymer 16 are dispersed together with the hydrophobic binder in a solvent, to prepare a magnetic coating material for formation of the magnetic layer 6.

A surfactant is preferably also added to the magnetic coating material. If the magnetic layer 6 formed from the magnetic coating material contains a surfactant, the SmCo-based magnetic fine particles 12 will disperse even more easily in the hydrophobic binder and will be surrounded more readily by the hydrophobic binder, thus helping to further prevent oxidation of the SmCo-based nanoparticles 14 by moisture and improving the weather resistance and recording characteristics of the magnetic recording tape 2. Also, the rigidity of the magnetic layer 6 will be improved if it is formed from a magnetic coating material containing a surfactant.

The magnetic coating material may further contain publicly known dispersing agents, lubricants, head cleaning agents, curing agents, antistatic agents, and the like, added as necessary. When preparing the magnetic coating material for formation of the magnetic layer 6, a high molecular weight polyurethane with a molecular weight of about 10,000 may be added to the magnetic coating material. This can help ensure that the desired level of coated film strength is obtained for the magnetic recording tape 2. A thermosetting agent such as CORONATE 3041 by Nippon Polyurethane Industry Co., Ltd. may also be added as a curing agent. Since the curing agent forms strong crosslinks between the hydrophilic polymer 16 covering the SmCo-based nanoparticles 14 and the high molecular weight polyurethane, the magnetic recording tape 2 is imparted with coated film strength capable of withstanding high-speed running.

The materials used to form the undercoat layer 10 and backcoat layer 8 are mixed, kneaded, dispersed and diluted to produce coating materials for formation of each layer.

The coating material used to form the undercoat layer 10 may be a coating material obtained by dispersing a non-magnetic powder and a binder in a solvent. If necessary, the coating material may also contain added dispersing agents, head cleaning agents, lubricants and the like, similar to those used in the coating material for formation of the magnetic layer 6. As non-magnetic powders there may be used inorganic powders such as carbon black, α-iron oxide, titanium oxide, calcium carbonate and α-alumina, or mixtures thereof.

<Step 3>

In step 3, the surface of the base film 4 is coated with a coating material for formation of the undercoat layer 4, and then further coated with a magnetic coating material for formation of the magnetic layer 6, by known coating methods. The coating material for formation of the backcoat layer 8 is coated onto the side of the base film 4 opposite the side on which the coating material for formation of the undercoat layer 10 has been coated, thus forming a laminated body having a laminated structure comprising the precursors for each layer. If necessary, each layer precursor may be subjected to orientation, drying and calendering treatment. After curing of each layer precursor, the laminated body is cut into the prescribed shape, and optionally incorporated into a cartridge, to obtain a magnetic recording tape 2. The magnetic layer 6 of the magnetic recording tape 2 contains at least a hydrophobic binder, and SmCo-based magnetic fine particles 12 that include a core composed of SmCo-based nanoparticles 14 and a hydrophilic polymer 16 covering at least a portion of the surface of the core.

The preferred embodiment of a magnetic recording medium according to the invention described above is intended only to serve as illustration and is not necessarily limitative on the invention.

For example, the embodiment described above is a case wherein only one SmCo-based nanoparticle 14 is present for each SmCo-based magnetic fine particle 12, but this is not limitative and the SmCo-based magnetic fine particles 12 may have a structure with multiple SmCo-based nanoparticles 14 dispersed in each hydrophilic polymer 16. Also, the core composed of the SmCo-based nanoparticle is preferably a simple SmCo-based nanoparticle (primary particle) as in the embodiment described above, but it may also be a secondary particle composed of multiple SmCo-based nanoparticles.

Moreover, although the magnetic recording tape 2 of the embodiment described above has a structure wherein the undercoat layer 10 is laminated on the base film 4 and the magnetic layer 6 is laminated on the undercoat layer 10, there is no particular restriction of the magnetic recording tape 2 to this structure. For example, the magnetic recording tape may have a lower magnetic layer on the base film (support), with an upper magnetic layer laminated on the lower magnetic layer, or it may have a lower non-magnetic layer laminated on the base film with an upper magnetic layer laminated on the lower non-magnetic layer.

The magnetic recording tape 2 of the embodiment described above may also further comprise a soft magnetic layer containing a soft magnetic material between the base film 4 and magnetic layer 6. By including a soft magnetic layer in the magnetic recording tape 2, it is possible to achieve perpendicular magnetic recording and thus further improve the recording density of the magnetic recording tape 2 compared to conventional longitudinal magnetic recording. To achieve this effect more reliably, the soft magnetic layer is preferably adjacent to the magnetic layer 6. For example, the magnetic recording tape 2 shown in FIG. 1 may be provided with a soft magnetic layer between the undercoat layer 10 and magnetic layer 6. An Fe alloy or Co alloy, for example, may be used as the soft magnetic material.

In the process for production of a magnetic recording tape 2 according to this embodiment, the reaction mixture obtained by dissolving the Sm salt, Co salt and hydrophilic polymer in the solvent is first heated, and then the mixture containing the SmCo-based nanoparticles 14 and hydrophilic polymer 16, which is produced in the reaction solution, is removed from the reaction solution as a solid powder and the solid powder is used to prepare a magnetic coating material, but there is no limitation to this method of preparing the magnetic coating material. For example, instead of removing the mixture containing the SmCo-based nanoparticles 14 and hydrophilic polymer 16 from the reaction solution in the form of solid powder, the solvent of the reaction solution containing the mixture of the SmCo-based nanoparticles 14 and hydrophilic polymer 16 may be replaced with a coating material solvent in order to adjust the solid concentration, and then a hydrophobic binder directly added to the adjusted solution and the resulting mixture subjected to dispersion treatment, for use as the magnetic coating material. Also, although the SmCo-based magnetic fine particles 12 will mainly be produced in the mixture obtained in step 1 described above, they may also be produced at any point of step 1, step 2 or step 3.

Furthermore, the magnetic recording medium of the invention may be in the form of a magnetic card, magnetic disk or the like instead of the magnetic recording tape 2 described above.

The present invention will now be explained in greater detail through the following examples, with the understanding that these examples are in no way limitative on the invention.

### Example 1

### Synthesis of SmCo-Based Magnetic Fine Particles

A magnetic recording tape for Example 1 was produced in the following manner. First, 223.8 parts by weight of samarium acetylacetonate hydrate ([CH₃COCH═C(O—)CH₃]₃Sm.xH₂O) was dissolved in 20,000 parts by weight of 1,4-dioxane to prepare a Sm solution. Next, 534.4 parts by weight of cobalt acetylacetonate ([CH₃COCH═C(O—)CH₃]₃Co) was dissolved in 20,000 parts by weight of 1,4-dioxane to prepare a Co solution. A polymer solution was then prepared by dissolving 1000 parts by weight of poly(N-vinyl-2-pyrrolidone) in 90,000 parts by weight of tetraethylene glycol. The poly(N-vinyl-2-pyrrolidone) is a hydrophilic polymer used to cover the core composed of SmCo-based nanoparticles in the SmCo-based magnetic fine particles described hereunder.

The Sm solution and Co solution were then added to the polymer solution and mixed therewith to prepare a reaction mixture, which was stirred for about 12 hours. The stirred reaction mixture was then held at 110° C. and heated for about 1 hour under a stream of an inert gas (nitrogen, argon) in order to remove the moisture included in the Sm salt starting material and the alcohol solvent from the reaction mixture. This also removed the 1,4-dioxane used for dissolution of the Sm salt and Co salt, causing the Sm salt and Co salt to migrate into the alcohol solvent of the reaction mixture. The reaction mixture was then heated to reflux at 250-300° C. for about 3 hours under an inert gas stream for chemical reaction. This produced SmCo-based magnetic fine particles in the reaction mixture.

The reaction mixture was separated off by capillary and subjected to solvent exchange with absolute ethanol, after which it was dropped on a TEM observation grid and dried. TEM observation confirmed that the mean particle size of the synthesized SmCo-based magnetic fine particles was in the range of 2-7 nm. The reaction mixture was then allowed to stand and filtered with an ultrafilter to remove the tetraethylene glycol. The obtained filtrate was washed by addition of dehydrated acetone to dissolve out part of the hydrophilic polymer covering the core composed of the SmCo-based nanoparticles in the SmCo-based magnetic fine particles. This procedure adjusted the weight ratio of the total weight of the SmCo-based nanoparticles with respect to the hydrophilic polymer to 7/1, to prepare a slurry with a solid concentration of 80 wt %. The solid concentration was calculated as follows: [{(Weight of SmCo-based nanoparticles)+(weight of poly(N-vinyl-2-pyrrolidone))}){(weight of SmCo-based nanoparticles)+(weight of poly(N-vinyl-2-pyrrolidone))+(weight of acetone)}].

<Preparation of Magnetic Layer Coating>

A slurry with a solid concentration of 80 wt % was prepared by combining the aforementioned SmCo-based magnetic fine particle-containing slurry: 143 parts by weight (SmCo-based nanoparticles: 100 parts by weight, poly(N-vinyl-2-pyrrolidone): 14 parts by weight, acetone: 29 parts by weight, (SmCo-based nanoparticle/poly(N-vinyl-2-pyrrolidone)) ratio=7/1, solid concentration=80 wt %), high molecular urethane as a hydrophobic binder (Toyobo, Ltd.: UR8700): 2.7 parts by weight, α-Al₂O₃: 6 parts by weight, phthalic acid: 2 parts by weight and a mixed solvent (methyl ethyl ketone (MEK)/toluene/cyclohexanone=2/2/6 by weight), and the slurry was kneaded for 2 hours with a pressurized kneader. To the kneaded slurry there was added a mixed solvent (MEK/toluene/cyclohexanone=2/2/6 by weight) to prepare a slurry with a solid concentration of 30 wt %, and then the slurry was subjected to dispersion treatment with a horizontal pin mill packed with zirconia beads. To the dispersion treated slurry there was added a mixed solvent (MEK/toluene/cyclohexanone=2/2/6 by weight), stearic acid: 1 part by weight and butyl stearate: 1 part by weight to prepare a slurry with a solid concentration of 10 wt %. To 100 parts by weight of this slurry there was added 0.82 part by weight of an isocyanate compound (CORONATE L by Nippon Polyurethane Industry Co., Ltd.) to obtain the final coating material for the magnetic layer (magnetic coating material).

<Preparation of Coating Material for Lower Non-Magnetic Layer (Undercoat Layer)>

After putting α-Fe₂O₃: 85 parts by weight, carbon black: 15 parts by weight, an electron beam curing vinyl chloride-based resin: 15 parts by weight, an electron beam curing polyester-polyurethane resin: 10 parts by weight, α-Al₂O₃: 5 parts by weight, o-phthalic acid: 2 parts by weight, methyl ethyl ketone (MEK): 10 parts by weight, toluene: 10 parts by weight and cyclohexanone: 10 parts by weight into a pressurized kneader, kneading was performed for 2 hours to obtain a slurry. To the kneaded slurry there was added a mixed solvent (MEK/toluene/cyclohexanone=2/2/6 by weight) to prepare a slurry with a solid concentration of 30 wt %, and then the slurry was subjected to dispersion treatment for 8 hours with a horizontal pin mill packed with zirconia beads. To the dispersion treated slurry there was added a mixed solvent (MEK/toluene/cyclohexanone=2/2/6 by weight), stearic acid: 1 part by weight and butyl stearate: 1 part by weight to prepare a slurry with a solid concentration of 10 wt %, as a coating material for the lower non-magnetic layer.

<Preparation of Backcoat Layer Coating>

After putting nitrocellulose: 50 parts by weight, polyester-polyurethane resin: 40 parts by weight, carbon black: 85 parts by weight, BaSO₄: 15 parts by weight, copper oleate: 5 parts by weight and copper phthalocyanine: 5 parts by weight into a ball mill, the components were dispersed for 24 hours to obtain a mixture. To the mixture there was added a mixed solvent (MEK/toluene/cyclohexanone=1/1/1 by weight) to prepare a slurry with a solid concentration of 10 wt %. To 100 parts by weight of this slurry there was added 1.1 part by weight of an isocyanate compound to obtain a backcoat layer coating.

<Production of Magnetic Recording Tape>

The coating material for the lower non-magnetic layer was applied onto the surface of a 6.1 μm-thick polyethylene terephthalate film to a dry thickness of 2.0 μm, dried and subjected to calendering, and then the coated film was cured by electron beam irradiation to form a lower non-magnetic layer. The lower non-magnetic layer was next coated with a magnetic layer coating to a dry thickness of 0.20 μm and subjected to magnetic field orientation treatment and dried, after which it was calendered to form a magnetic layer. Next, the backcoat layer coating material was applied onto the back side of the polyethylene terephthalate film to a dry thickness of 0.6 μm, dried and calendered to form a backcoat layer. Thus, a magnetic recording tape precursor was obtained having the respective layers formed on both sides of the polyethylene terephthalate film. The magnetic recording tape precursor was then placed in an oven at 60° C. for 24 hours for thermosetting. The thermoset magnetic recording tape precursor was cut to a ½-inch (12.65 mm) width to obtain a magnetic recording tape for Example 1.

### Evaluation of Recording Characteristic

The recording characteristic of the magnetic recording tape of Example 1 was measured using a MIG head for recording at a recording wavelength of 0.2 μm and a GMR head for playback. A drum tester was used for measurement of the recording characteristic. The results of the measurement indicated that the magnetic recording tape of Example 1 had a satisfactory recording characteristic.

### Comparative Example 1

### Preparation of Magnetic Layer Coating

To a slurry of the same SmCo-based magnetic fine particles used in Example 1: 143 parts by weight, (SmCo: 100 parts by weight, poly(N-vinyl-2-pyrrolidone): 14 parts by weight, acetone: 29 parts by weight, (SmCo-based nanoparticle/poly(N-vinyl-2-pyrrolidone)) weight ratio=7/1, solid concentration: 80 wt %) there were added polyvinyl alcohol (molecular weight: 10,000): 2.7 parts by weight as a hydrophilic binder, α-Al₂O₃: 6 parts by weight, phthalic acid: 2 parts by weight and butyl alcohol to a solid concentration of 80 wt %, and the mixture was kneaded for 2 hours with a pressurized kneader. To the kneaded slurry there was added butyl alcohol to prepare a slurry with a solid concentration of 30 wt %, and then the slurry was subjected to dispersion treatment with a horizontal pin mill packed with zirconia beads. To the dispersion treated slurry there were added butyl alcohol, stearic acid: 1 part by weight and butyl stearate: 1 part by weight to prepare a slurry with a solid concentration of 10 wt %. To 100 parts by weight of this slurry there was added 0.82 part by weight of a water-soluble polyisocyanate compound (Dainippon Ink & Chemicals, Inc.) to obtain the final coating material for the magnetic layer.

<Preparation of Lower Non-Magnetic Layer Coating Material and Backcoat Layer Coating>

The lower non-magnetic layer coating material and backcoat layer coating were prepared as in Example 1.

<Production of Magnetic Recording Tape>

The coating material for the lower non-magnetic layer was applied onto the surface of a 6.1 μm-thick polyethylene terephthalate film (base film) to a dry thickness of 2.0 μm, dried and subjected to calendering, and then the coated film was cured by electron beam irradiation to form a lower non-magnetic layer. The lower non-magnetic layer was next coated with the magnetic layer coating material of Comparative Example 1 to a dry thickness of 0.20 μm and subjected to magnetic field orientation treatment and dried, after which it was calendered to form a magnetic layer. The magnetic layer was then coated with a fluorine solution (perfluoropolyether: 1 part by weight, n-hexane: 1000 parts by weight) and dried to form a water-repellent layer. Next, the backcoat layer coating material was applied onto the back side of the polyethylene terephthalate film to a dry thickness of 0.6 μm, dried and calendered to form a backcoat layer. Thus, a magnetic recording tape precursor was obtained having the respective layers formed on both sides of the polyethylene terephthalate film. This magnetic recording tape precursor was placed in an oven at 60° C. for 24 hours for thermosetting. The thermoset magnetic recording tape precursor was cut to a ½-inch (12.65 mm) width to obtain a magnetic recording tape for Comparative Example 1.

(Weather Resistance Test)

The magnetic recording tapes of Example 1 and Comparative Example 1 were allowed to stand for one week in an environment with a temperature of 65° C. and a humidity of 90% RH. After about one week, the magnetization degradation rates of the magnetic recording tapes of Example 1 and Comparative Example 1 were measured, resulting in a value of 5% for Example 1 and a value of 6% for Comparative Example 1. This confirmed that the weather resistance of Example 1 was superior to that of Comparative Example 1 which had a water-repellent layer on the surface of the magnetic layer rendering the magnetic layer resistant to penetration of moisture, and providing a structure with a more reliable magnetic property.

What is claimed is:

1. A magnetic recording medium provided with a magnetic layer comprising at least SmCo-based magnetic fine particles and a hydrophobic binder,
wherein the SmCo-based magnetic fine particles include a core composed of SmCo-based nanoparticles and a hydrophilic polymer covering at least a portion of the surface of the core.

2. A process for production of a magnetic recording medium characterized by comprising
a step in which a reaction mixture comprising a Sm salt, a Co salt and a hydrophilic polymer dissolved or dispersed in a solvent is heated to obtain a mixture containing SmCo-based nanoparticles and the hydrophilic polymer,
a step in which a hydrophobic binder is added to the mixture to obtain a magnetic coating material and
a step in which the magnetic coating material is used to form a magnetic layer comprising at least a hydrophobic binder and SmCo-based magnetic fine particles that include a core composed of SmCo-based nanoparticles and a hydrophilic polymer covering at least part of the surface of the core.

3. A process for production of a magnetic recording medium according to claim 2, wherein a surfactant is further added to the magnetic coating material.
